(19) United States
(12) Patent Application Publication
(10) Pub. No.: US 2024/0289865 A1
(43) Pub. Date: Aug. 29, 2024

(54) TECHNIQUES FOR GENERATING PRODUCT RECOMMENDATIONS USING MACHINE LEARNING AND IMAGE ANALYSES

(71) Applicant: StyleRiser Inc., Bakersfield, CA (US)

(72) Inventors: Margrit Sieglinde Hunsmann, Schwäbisch Gmünd (DE); Mark Hunsmann, Schwäbisch Gmünd (DE); Glen Kenneth Brown, Bakersfield, CA (US)

(21) Appl. No.: 18/588,612

(22) Filed: Feb. 27, 2024

Related U.S. Application Data
(60) Provisional application No. 63/487,205, filed on Feb. 27, 2023.

(51) Int. Cl. G06Q 30/0601

(52) U.S. Cl. CPC G06Q 30/0631

(57) ABSTRACT

Described herein are techniques for using software-based algorithms, and machine learning models, to generate product recommendations for users. By way of example, product information is obtained from one or more third-party partner systems (e.g., websites, ERP or inventory management systems, and so on). The product information is then analyzed to derive product characteristics (e.g., color, size, cut, fashion classification, and so forth) for each product. Depending upon the combination of product characteristics derived for a product, the product is assigned or associated with one of several predefined product profiles or styles. The product profile is then used to map or match the product with a style profile of an end-user of the product recommendation system, and ultimately, one or more product recommendations are presented to an end-user.

### RELATED APPLICATIONS

This application claims the benefit of and priority to U.S. Provisional Patent Application No. 63/487,205, with title, “Techniques for Generating Product Recommendations using Machine Learning and Image Analyses,” filed on Feb. 27, 2023, which is hereby incorporated by reference in its entirety for all purposes.

### TECHNICAL FIELD

The present application generally relates to techniques for analyzing images, using pretrained, machine learned models, for the purpose of generating product recommendations. More precisely, the present application describes a technology platform that uses image analyses to determine characteristics of users and characteristics of products, and then uses matching logic to select various products for presentation and recommendation to an end-user. Embodiments of the technology platform may benefit consumers and retailers in the context of both online (e.g., web-based shopping), as well as shopping in a physical retail location.

### BACKGROUND

For many years now, online or web-based shopping has slowly been increasing in popularity, complementing what is now commonly referred to as the brick-and-mortar experience-shopping at physical retail stores or locations. When it comes to online or web-based shopping, there are many issues that may arise. First, one of the primary challenges for both consumers and retailers derives from the inability of the consumer to physically touch and interact with products. For instance, with online or web-based shopping, because a consumer cannot physically interact with and temporarily try on (e.g., dress in, or wear) various items, the consumer may not have confidence in selecting the appropriate color, size, fabric, style, etc., for a particular item. Furthermore, because the consumer cannot physically interact with items, the consumer cannot physically mix and match items to determine whether two or more items complement one another. Additionally, many consumers generally lack a fundamental understanding of the product characteristics that are most likely to be complementary to the consumer and their appearance. When shopping online, there generally are no opportunities to seek the advice and guidance of a fashion expert, as may be the case when shopping at a physical retail store.

In some instances, the aforementioned issues may prevent a consumer that is shopping online from concluding a purchase transaction for an item. In other instances, it may lead a consumer that is shopping online to purchase an incorrect or ultimately undesirable item, leading the consumer to eventually return the item to the retailer after having an opportunity to evaluate the item. This may of course increase operating costs for the retailer. Furthermore, a consumer that is shopping online and makes several purchases, only to return the purchased items after having the opportunity to evaluate the items, may ultimately lose confidence and refrain from shopping online with a particular retailer.

When shopping at a physical retail store, consumers can physically interact with and evaluate various items, while mixing and matching combinations of items. However, even in the context of the physical retail shopping experience, a consumer may lack confidence in his or her own understanding of fashion. Specifically, a consumer may not know what items best complement the consumer's own individual appearance. In such instances, a consumer may solicit feedback from a retail clerk. However, many retail stores may have only a few employees, and in many cases, those employees may have limited fashion expertise. Therefore, even in the context of the physical retail shopping experience, the advice and guidance provided by a retail clerk may not increase a consumer's confidence in deciding on a purchase transaction for a particular item.

### BRIEF DESCRIPTION OF THE DRAWINGS

Embodiments of the present invention are illustrated by way of example and not limitation in the figures of the accompanying drawings, in which:

FIG. 1 is a high-level overview of the various elements of a technology platform for providing personalized product recommendations, consistent with embodiments of the present invention;

FIG. 2 is a diagram illustrating a network computing environment in which a system for providing product recommendations may be implemented and integrated with various third-party (e.g., retailers) websites and applications, consistent with embodiments of the invention;

FIG. 3 is a diagram illustrating how a machine learned model may be trained, consistent with embodiments of the invention;

FIG. 4 is a block diagram illustrating a software architecture, which can be installed on any of a variety of computing devices to perform methods consistent with those described herein;

FIG. 5 illustrates a diagrammatic representation of a machine in the form of a computer system within which a set of instructions may be executed for causing the machine to perform any one or more of the methodologies discussed herein, according to an example embodiment.

### DETAILED DESCRIPTION

Described herein are methods and systems for leveraging machine learning models to analyze images and data relating to end-users, on the one hand, and products, on the other, in order to make product recommendations. Specifically, the present disclosure describes techniques for using a style profile of an end-user, in both an e-commerce and physical retail shopping context, to generate recommendations for product listings that may be hosted by various retailer's websites and/or web-based applications as well as offered for sale in a physical retail store. In the following description, for purposes of explanation, numerous specific details and features are set forth in order to provide a thorough understanding of the various aspects of different embodiments of the present invention. It will be evident, however, to one skilled in the art, that the present invention may be practiced and/or implemented with varying combinations of the many details and features presented herein.

### SUMMARY

Consistent with various embodiments, software-based algorithms that leverage machine learning models are used to determine what is referred to herein as an end-user's personal style profile. Accordingly, a personal style profile is created for an end-user based on the end-user's data, such as one or more images of the end-user (specifically, an image of the end-user's face), and in some instances, answers that the end-user provides to one or more survey questions. An end-user's style profile is then used as input to a product selection or matching module, which evaluates product data and the user's personal style profile in order to provide personalized product recommendations to the end-user.

Consistent with some embodiments, to generate a personal style profile, the end-user provides an image of the end-user's face to a server-based product recommendation system, where various image analyses are performed. One of the analyses includes determining a color type of the user based on color sampling of the image of the face of the user. Predetermined locations of the user's face are identified using a trained machine learned model and color samples are taken at these locations. The color samples are weighted and evaluated to determine a color type of the end-user. The color type of the end-user can be selected from multiple color types based on the color sampling. With some embodiments, the determined color type may be a set or palette of colors that complement the user, for example, based on the skin tone or complexion of the user. Details of the color type determination system and method are described in related, U.S. Pat. No. 10,984,559, entitled, “Color Engine.”

An image of the user's face is also analyzed to determine a style profile of the user. Facial features and facial characteristics of the user are identified in the image using one or more pre-trained machine learned models. The identified facial features and characteristics may include a face shape, facial lines and facial proportion(s), among other things. The output of the various machine learned models can be combined, based on various rules, to map certain combinations of facial features and characteristics to one or more predefined style profiles. By way of example, certain combinations of facial characteristics may be mapped to one of several predetermined style profiles. When the outputs of the machine learned models indicate a particular end-user possesses a combination of facial characteristics associated with one of the predetermined style profiles, the style profile is then assigned or associated with the end-user. With some embodiments, each facial characteristic, and each style profile may also be assigned a confidence score, based on the output(s) of the one or more machine learned models. Accordingly, the confidence scores can be leveraged to determine the extent to which a particular end-user has or is best represented by a specific style profile. For example, product recommendations may be ranked or weighted, in part, based on a confidence score associated with a style profile assigned to a particular end-user. With some embodiments, the color profile may be included as one facial characteristic or facial feature in determining an end-user's style profile, whereas in some alternative embodiments, the personalized color profile or palette of an end-user exists separate and apart from the end-user's style profile. Additionally, with some embodiments, an end-user may be prompted, for example, via various user interfaces of an application or web page, to provide answers to specific survey questions. These answers may be used in the mapping or assigning of the end-user to one or more style profiles. Further details of the style profile engine are described in related, U.S. patent application Ser. No. 18/045,424, entitled “Style Profile Engine,” filed on Oct. 10, 2022.

Consistent with various embodiments, product data and product listings for different products (e.g., clothing, shoes, jewelry, accessories, and so forth), or fashion pieces, are also evaluated to determine various product attributes or characteristics. By way of example, the color, the shape and/or cut, as well as the fabric of a product can be determined based on analysis of product data. Consistent with some embodiments, the product data may be obtained via product listings hosted at third party websites, using data ingestion technology—sometimes referred to as web-crawling technology. In other instances, product data may be obtained over a computer network using public or proprietary application programming interface (API) calls to a server that hosts the data, and in some instances, hosts the product listings for the products that are being offered for sale. With some embodiments, product data may be obtained and analyzed automatically, with little or no human intervention, whereas in other instances, some product data may be automatically obtained and analyzed while some product data may be manually created based on a person reviewing a combination of images and meta-data relating to various products. In some instances, product data for a particular retailer may be provided by the retailer, such that it can be uploaded directly and automatically from a storage device to a database or accessed over a network. With some embodiments, a third-party may have an enterprise resource planning (ERP) system that is integrated to provide product data on an on-going basis.

With some embodiments, an end-user's personal style profile is evaluated against the product profiles to generate personalized product recommendations for the user. For example, in some instances, there may be a one-to-one mapping of style profiles to product profiles, such that, a product that is assigned to a particular product profile (e.g., “Classic”) may naturally map to an end-user who has been assigned to a style profile that corresponds with the product profile. In other instances, complex rule-based matching may be implemented so that products having various combinations of product attributes or characteristics, determined via the manual or automated analysis, will map to one or more user style profiles. With some embodiments, colors from the user's color profile as well as various answers to survey questions may be used to either select certain products, or filter out (e.g., exclude certain products). For instance, with some embodiments, various colors from an end-user's personalized color palette may be used to boost a ranking or relevance score assigned to a product, for example, when the product is known to be or have the corresponding color. Accordingly, by implementing the software algorithms that are used to generate the style profiles and the product profiles, and then map or match end-users to products based on logic that mirrors that used by a fashion consultant or fashion expert, that automation of the generation of product recommendations can be done in a manner that ensures the selected and recommended products are likely to be complementary to the user. Additionally, with some embodiments, a product recommendation can include an indication of the strength of the recommendation, for example, based on various confidence scores that may be assigned to and associated with style profiles and/or product profiles, or confidence scores assigned to or associated with individual characteristics of the user and/or product. Accordingly, product recommendations can also include an indication of how daring or experimental a product may be for a particular end-user. This will allow the user to safely experiment with various fashion decisions, while keeping the recommended products rooted to those that are likely to work best for the user.

Consistent with some embodiments, an end-user's style profile may be one component of what will be referred to herein as an end-use's style identity or StyleID. For instance, whereas the style profile may be derived based on analyses of an image of the face of the end-user, a StyleID may be a more holistic representation of the end-user, which may, for example, include a variety of additional data that could be used in selecting products for product recommendations, filtering or excluding products, and/or concluding transactions for the purchase of products. By way of example, a StyleID may include data provided by the end-user relating to various product preferences, brand preferences, style preferences, and so forth. This data can be used by the product selection module, for example, by weighting various factors that are considered when generating a ranking or relevance score for a product to be recommended to an end-user. Similarly, the StyleID may include information about the end-user, such as the age of the end-user, the residential location of the end-user, information about the end-user's employment (e.g., industry, office location), and so forth. In some instances, the StyleID may include information that can aid in the rapid conclusion of a purchase transaction. For example, in some instances, an end-user may provide as part of his or her StyleID information indicating payment preferences (e.g., credit card account information) and/or shipping preferences (e.g., delivery address, etc.). The end-user may be prompted to answer survey questions that are specifically designed to reveal latent desires of the user, for purposes of selecting and/or filtering products when generating product recommendations and/or for the purpose of mapping or assigning the user to one of a number of predetermined style profiles. Finally, a StyleID may include the equivalent of an end-user account identifier for use with third-party websites. For example, a StyleID may provide a mechanism for authenticating an end-user of the product recommendation system when the end-user is using the product recommendation system as integrated with a third-party system-for example, such as a third-party website, or a third-party ERP system or inventory management system. In such scenarios, the style profile of the end-user can be used to make recommendations of product listings hosted by third-party websites or available at retail locations, with the authorization of the end-user (e.g., using his or her StyleID).

Consistent with some embodiments, the style profile and/or the StyleID may be stored on a server in association with an account (e.g., protected by and accessible via a user login and password). Accordingly, with some embodiments, product recommendations are made at the request or with authorization by the end-user, when the end-user is using a mobile application or accessing a website operated by the entity that has provided the style profile and/or StyleID. However, in some instances, the StyleID (or, just the style profile) may be integrated with various third-party systems. Accordingly, in some instances, an end-user may be prompted to provide authorization for a third-party website to access information in the end-user's account (e.g., the StyleID or style profile), on behalf of the end-user. This may be achieved, for example, using an open standards technology, such as OAuth, or more precisely, OAuth 2.0. By authorizing a third-party website to access an end-user's style profile or StyleID, the end-user can be presented with a curated selection of products on the third-party retailer's website, or products available in a retail location, which are selected and/or ranked for priority presentation based on the personalized style profile of the end-user. With some embodiments, the integration of the StyleID with a third-party system may provide for the streamlining of the purchase process for the end-user.

Consistent with some embodiments, an end-user may also be presented with a metric or score that is intended to reflect various actions taken by the end-user. For instance, with some embodiments, a metric or score may be derived for each end-user—referred to herein as a StyleIQ. The StyleIQ may reflect a measure of the level of activity an end-user has taken with respect to the system—and thus, is provided as a proxy for how well the end-user understands or knows his or her own style. Accordingly, with some embodiments, the more information that an end-user provides, the more and better product recommendations can be generated, and the higher the end-user's StyleIQ will be. If, for example, the end-user frequently accesses the product recommendation system, and has on multiple occasions provided selfie images to generate a color profile and style profile, the end-user's StyleIQ may be increased to reflect the activity of the end-user. Similarly, if the end-user purchases recommended products, and provides positive feedback regarding such purchases, this may positively reflect in the end-user's StyleIQ.

As users utilize their StyleIDs and access various third-party websites, the product recommendation system will obtain and log data relating to the shopping and browsing activity and product purchases of users. This collected information can be analyzed and evaluated to provide various insights regarding users shopping behavior, and to assist with refining and/or training the automation used to generate a user's style profile. Additionally, such information can be offered to third-party partner retailers and/or product providers, so that these parties can improve their product offerings and the overall shopping experience. For example, the insights can be used to forecast fashion trends, which may be of interest to fashion designers, manufacturers and retailers.

With some embodiments, a personalized online storefront may be created for each user and their style profile. For example, rather than directing a user to individual retailer websites, the product recommendation system may provide a user with access to a single user interface displaying product recommendations from multiple partner retailers. This personalized online storefront may display relevant products from these retailers to the user based on their individual style profile(s). In this manner, the user can be provided a “one-stop” shopping experience where they can browse and purchase a variety of fashion items that have been curated for them based on their style profile. s

[symbol]

With some embodiments, an application (e.g., a mobile app or desktop computer app, or web-based app) may provide a user interface that allows a user to capture an image of a product, upload an image of a product, or otherwise specify a product (e.g., by providing a link), for the purpose of having that product analyzed for overall suitability with the user's style profile. For instance, the information relating to the product identified by the user is obtained by the product recommendation system and then analyzed to automatically determine various product characteristics, and then based on these characteristics, the user is provided information as to how well the product matches or corresponds with the user's style profile. In some instances, for example, individual product characteristics may be scored to reflect the extent to which the individual product characteristics (e.g., color, fit, cut, fabric, fashion style) are a match with a user's style profile. The score for a product characteristic may be presented, for example, as a metric (e.g., a number in a predetermined range—one to five), or via a scale (e.g., one to five stars), or color-coded, where specific colors indicate the extent of a match between the product characteristic and the style profile.

With some embodiments, the product recommendation system may compare results of the product analysis performed on the product listings of a particular retailer, with product data maintained by the retailer. For instance, after deriving a product profile for various products offered by a retailer, the product profiles may be compared with inventory information maintained by the retailer. As such, discrepancies in how products are classified may be determined. Additionally, the data generated by the product recommendation system may be useful in determining the extent to which the product profiles of the products being offered by the retailer are suitable for the target customer of the retailer. For instance, by logging and analyzing data relating to the style profiles of users who access certain retail websites, this information can be compared with product profiles of the products offered, for the purpose of determining potential gaps (e.g., missing colors, cuts, fabrics, and so on) in product offerings. Accordingly, information provided by the product recommendation system may be useful to retailers for both marketing strategy as well as procurement.

With some embodiments, product recommendations may be generated based on complex rule-based matching logic, which maps user style profiles to product profiles, based on individual characteristics of each. However, over time, as data regarding actual product purchases is captured, additional machine learned models may be deployed to predict product preferences for style profiles, based on historical data that indicates a relationship between characteristics associated with style profiles and characteristics of products as captured in product profiles. For example, a supervised machine learning algorithm may be used to learn the relationship between user characteristics, as reflected in style profiles, and product characteristics, as reflected in product profiles, by analyzing the product preferences of users based on the historical purchase data. Accordingly, over time, the recommendations that are derived by product recommendation system may evolve from a primarily rules-based approach to a data-driven machine learned model approach.

Consistent with some embodiments, the product recommendation system may be integrated with a retailer's enterprise resource planning (ERP) system, point-of-sale system, and/or inventory management system, providing for the ability to recommend products to those shopping in physical retail locations. Specifically, when a customer is shopping in a retail location, products that are available for sale at the retail location can be recommended to the customer, based on the customer's personal profile and StyleID. By way of example, with some embodiments, a computer-based kiosk with a touch-screen display may be provided within a retail store. A consumer may interact with a user interface of the kiosk to identify him or herself and access his or her style profile, if the consumer had previously created a style profile. In some instances, the style profile may be retrieved by the computer-based kiosk making a request over a network, while in other instances, a consumer may use a mobile app to directly share his or her style profile as stored on his or her mobile app (e.g., via Bluetooth, or some other wireless protocol). In either scenario, the kiosk may access information about the customer, including his or her personal style profile and StyleID, for purposes of identifying and recommending products that are offered for sale at the physical retail location.

A computer-based kiosk may include an image capturing device (e.g., a camera). Accordingly, consistent with some embodiments, a customer who had not previously created a personal style profile may create a personal style profile via the computer-based kiosk while physically present in the retail store. For example, an application executing at the computer-based kiosk may prompt the customer to create a style profile, in much the same way that the customer would otherwise create his or her style profile via his or her own mobile computing device or other personal computing device. The user interface of the kiosk-based application may display images of the recommended products, and provide detailed instructions relating to the location, within the physical retail store, of the recommended products-in some instances including walking directions from the kiosk to the actual location of the recommended products within the retail store. While it may be particularly advantageous to recommend products that are in stock and available for purchase at the retail store, in some instances, such as when a particular variation (e.g., size, color, style) of a recommended product is currently out of stock, the user interface of the computer-based kiosk application may provide the ability to order a product that would then be delivered to a preferred address of the customer.

Consistent with other embodiments, similar functionality may be provided via a mobile application. For example, instead of interacting with a user interface provided by an in-store kiosk, a mobile application residing and executing on a mobile device of the customer may provide a user interface that displays product recommendations for a product located in a physical retail store when the consumer is physically present within the store. Similarly, with other embodiments, a retail clerk employed by the retailer may be provided with a mobile computing device, such as a tablet computing device. The retail clerk may then assist customers with help from information accessible via a user interface of the tablet computing device. For example, a customer may authenticate him or herself using the tablet computing device, or by sharing data via his or her mobile application—e.g., wirelessly over a network—thereby allowing the retail clerk to access product recommendations that are generated based on the personal style profile and/or StyleID of the customer. In this scenario, the product recommendations can be limited to inventory that is actually on hand—that is physically available for purchase at the retail store. In yet other embodiments, a store clerk may assist a customer by using a mobile computing device, such as a tablet computer, to take the required steps for establishing a style profile. For example, the store clerk may take a photo of a customer using the tablet computer, and then prompt the customer for information which is entered via a user interface of an application executing on the tablet. In this way, the store clerk can help to create a style profile for a customer in real time, as the customer is shopping at a retail location.

Consistent with the various embodiments of the invention, techniques that are described herein assist a user with selecting products (e.g., fashion pieces) for purchase and provide the user with confidence in such purchases, in the context of both online and retail store shopping experiences. Additionally, retailers can use these innovations to present personalized and curated product selections, increasing the likelihood of a purchase by a user and reducing potential customer dissatisfaction with a purchase. A variety of other advantages that arise from the innovate subject matter set forth herein will be readily apparent from the following description of the several figures.

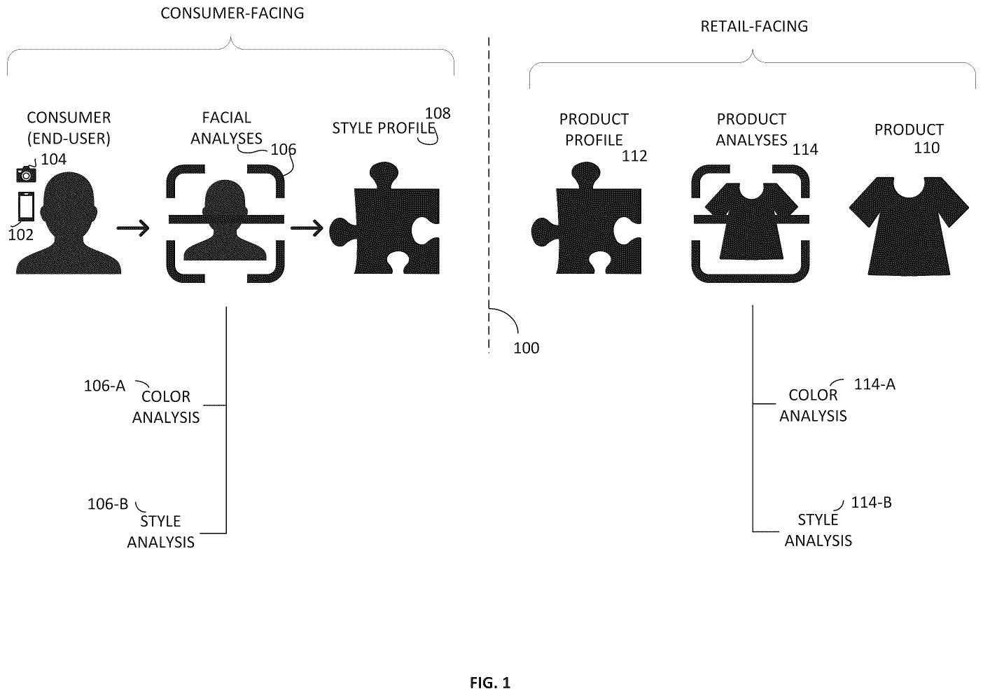

FIG. 1 illustrates a high-level overview of a system, consistent with embodiments of the present invention, configured to generate and present product recommendations to an end-user. As illustrated in FIG. 1, a platform or system for generating product recommendations has two primary components—a consumer-facing component for generating style profiles and, optionally, color profiles for end-users, and a commercial- or retail-facing component for analyzing products to create product profiles. As shown in FIG. 1 to the left of the dashed line 100, a consumer-facing component of the system is primarily aimed at obtaining information from an end-user or simply a user (e.g., a customer, consumer, or potential consumer) for the purpose of generating a digital representation of the end-user—specifically, a style profile and optionally a color profile.

An end-user may use any of a variety of devices to capture an image of his or her face—what is referred to herein as a selfie, or selfie photo. With some embodiments, a mobile application executing on a mobile computing device 102 (e.g., a smartphone, or similar) may present a user interface that enables the user to operate an image sensor or camera of the mobile computing device to capture a selfie. In other embodiments, a web-based application may have a user interface allowing the user to operate a web cam or similar imaging sensor connected to a laptop or desktop computer. Alternatively, the web-based application may have a user interface allowing for the selection, and uploading to a server, of an image captured with an external camera device 104. In yet other embodiments, an in-store, computer-based kiosk (not shown) may have an integrated image capturing device (e.g., a camera or image sensor), allowing a customer that is shopping in a retail store to create a style profile via the kiosk. Similarly, a retail clerk or store employee may be provided with a mobile computing device having an image capturing device, such that the retail clerk can generate a style profile for a consumer while the consumer is shopping at a retail location.

Consistent with some embodiments, the image of the user may be obtained from a video clip. For instance, with some embodiments, a video clip that is uploaded to a server may be analyzed to detect within the clip one or more sequential frames that include an image of a face, suitable for further analysis. Accordingly, in some instances, a single frame from the video clip may be selected for analysis, whereas in other instances, multiple sequential frames may be selected and then blended (e.g., averaged) or combined in some advantageous way to improve or enhance the image of the user's face, before the image is subject to additional analyses for purposes of detecting facial characteristics.

Consistent with some embodiments, facial analyses 106 are performed on the selfie that is provided by the user, in order to generate what is referred to herein as a user's style profile 108. Generally, the facial analyses 106 involve both color analyses 106-A, and style analyses 106-B. Consistent with some embodiments, the style analyses 106-B involve using one or more machine learned models to analyze the selfie image and to detect or recognize certain facial features and facial characteristics (e.g., a classification task), such as a shape of the face, characteristics relating to lines present in the image of the face, proportions of the face and/or facial features, detection of various facial features (e.g., cheek dimples, facial hair, etc.), and so forth. With some embodiments, the facial characteristics that are recognized or identified as a result of performing the color analyses and the style analyses are combined for purposes of then mapping various combinations of facial characteristics to a single style profile 108 for the user. In some instances, a user may be assigned or associated with more than one style profile. For example, combinations of facial characteristics may be scored, such that a particular style profile may be applicable to a user only when the combined scores of the various facial characteristics that map to a particular style profile exceed some threshold score associated with the style profile. Similarly, in some instances, a confidence score may be associated with various user style profiles, such that the confidence score can be used as a metric indicating the extent to which a particular user matches a specific user style profile. In such a scenario, the higher the confidence score is for a particular user style profile, the more likely the user fits or matches the style profile. Accordingly, when a product matches a style profile, the higher the confidence score is for the style profile assigned to the end-user, the more likely it is that the product will be a good fit for the user. In some instances, results of the color analyses may be provided separately from the style profile that results from the style analyses, while in other instances, various color characteristics may be combined with other characteristics to map an end-user to a style profile.

In addition to creating a style profile for a user (as shown to the left of dashed line 100), as shown in FIG. 1 to the right side of the dashed line 100, the overall platform or system includes tools and services for analyzing products 110 (e.g., clothes, apparel, shoes, attire, accessories, etc.), and related information about those products, in order to generate for each product a product profile 112. Similar to a style profile 108, a product profile 112 is a digital representation of the attributes or characteristics of a product. Accordingly, a product profile 112 may encapsulate information about a product, such as, but not limited to: shape, size, fabric, color, fashion classification, among others.

To generate the product profile 112, various product analyses 114 are performed. For instance, in much the same way that the facial and color analyses are used to derive a style profile and a color profile for a user, similar analyses is used to derive or identify characteristics of a product. Various combinations of the product characteristics can then be used to map the product to a product profile 112. As described in greater detail below, the product data from which the product characteristics are derived may be obtained in various ways. By way of example, product data may be obtained using a data ingestion engine that is specifically designed to “crawl” or otherwise access web pages of one or more particular websites. In other cases, the product data may be obtained automatically over a computer network via an API call directed to an API server that may be hosting various product listings. In other instances, the product data may be provided directly by a third party, such that the data can be uploaded to a database. In some instances, the product data may be manually created by a person analyzing one or more images of a product listing, and then manually entering the relevant product data. Finally, as described below, many of the product characteristics that are used to map a product to a product profile, and thus a style profile, are derived via analyzing images obtained from a product listing, where the analyses involve using pretrained machine learned models to detect or identify various product characteristics, such as color, fit, cut, and so forth.

With some embodiments, product selection rules or matching logic may be used to map a user's style profile to a product profile. For instance, with some embodiments, there may be a one-to-one mapping of a style profile to a product profile, and ins some instances, the style and product profile may share a similar naming scheme or taxonomy. For example, a certain combination of facial characteristics may map to a style profile that is referred to as “Classic.” Similarly, a certain combination of product characteristics may also map to a product profile that is referred to by the same name, for example, “Classic.” Alternatively, with some embodiments, there may be a one-to-many mapping of style profiles to product profiles. In yet other embodiments, various matching rules may be used to directly determine the extent to which certain products, having various combinations of product characteristics, map to one or more style profiles. Product selection and recommendation can thus depend on the extent to which a product profile of a product corresponds with or matches criteria set forth to map the product profile to a user's style profile.

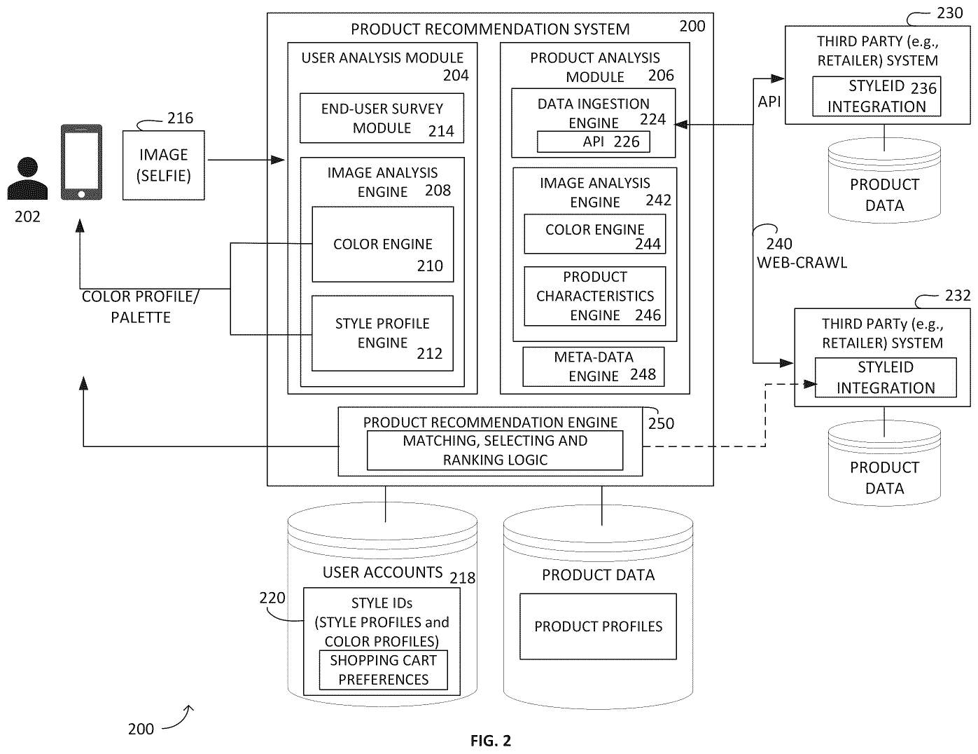

FIG. 2 is a diagram illustrating a network computing environment in which a system 200 for providing product recommendations may be implemented and integrated with various third-party (e.g., retailers) ERP systems, websites, and applications, consistent with embodiments of the invention. As illustrated in FIG. 2, end-users 202 may interact with the product recommendation system directly, over a computer network (not shown), using any of a variety of client computing devices. For example, the product recommendation system 200 may be client-server based, and may be accessible via mobile or desktop applications, including conventional web browser applications, or alternatively, dedicated applications developed to operate natively on any of a variety of popular mobile operating systems, such as Android® and iOS®. Using an application, the end-user 202 provides a selfie image to the user analysis module 204 of the system 200.

As shown in FIG. 2, the product recommendation system 200 includes a user analysis module 204. The user analysis module 204 includes an end-user survey module 214, and an image analysis engine 208. The end-user survey module 214 facilitates the conducting of end-user surveys with end-users. For example, the end-user survey module 214 will prompt, via various user interfaces, users to answer survey questions, and then obtain the answers to those survey questions. The image analysis engine 208 includes a color engine 210 and a style profile engine 212. The color engine 210, the operation of which is covered in depth in related U.S. Pat. No. 10,984,559, analyzes the selfie image 216 received from the end-user 202 to generate color information for the end-user. Similarly, the style profile engine 212, the operation of which is covered in depth in U.S. patent application Ser. No. 18/045,424, with title, “Style Profile Engine,” uses various machine learning techniques to generate a user style profile for the end-user.

Consistent with some embodiments, the user analysis module 204 may also prompt the end-user to provide information that is stored in a database as part of an end-user's user account 218. This information may, for example, be part of what is referred to herein as a StyleID 220. For instance, whereas the style profile may be derived based on analyses of an image 216 of the face of the end-user, a StyleID may be a more holistic representation of the end-user, which may, for example, include a variety of additional data that could be used in selecting products for product recommendations, filtering or excluding products, and/or concluding transactions for the purchase of products. By way of example, a StyleID may include data provided by the end-user relating to various product preferences, brand preferences, style or fashion preferences, size preferences, and so forth. This data can be used by the product selection module, for example, by weighting various factors that are considered when generating a ranking or relevance score for a product to be recommended to an end-user. Similarly, the StyleID 220 may include information about the end-user, such as the age of the end-user, the residential location of the end-user, information about the end-user's employment (e.g., industry, office location), and so forth. By way of example, product recommendations may be derived, taking into consideration the industry of the user, as determined based on employment information included in the user's StyleID. In some instances, the StyleID may include information that can aid in the rapid conclusion of a purchase transaction. For example, in some instances, an end-user may provide as part of his or her StyleID information indicating payment preferences (e.g., credit card account information) and/or shipping preferences (e.g., delivery address, etc.).

In addition to the user analysis module 204, the product recommendation system 200 includes a product analysis module 206. The product analysis module 206 is configured to obtain data from any of a number of sources relating to products, and then process that data to determine product characteristics associated with products that are offered for sale via online product listings—typically, as hosted by one of a number of third-party systems 230 and 232, which may be ERP systems and/or websites, or other inventory management systems. Accordingly, the product analysis module 206 includes what is referred to herein as a data ingestion engine 224. The data ingestion engine 224 may utilize web crawling technology to directly request and receive product data associated with product listings that are associated with various third-party sites (e.g., 232). By way of example in FIG. 2, the line with reference number 240 indicates that the third-party site 232 is being crawled (e.g., data is being automatically retrieved and ingested), for the purpose of obtaining product data associated with product listings that are hosted by the third-party site 232. Accordingly, the product data, including images, may be automatically ingested and then provided to the image analysis engine for determining further product characteristics.

In addition, the data ingestion engine 224 includes an API module 226 for making API requests to third-party services and systems. For example, some third-party systems may have an API server that will respond to appropriately formatted API requests by providing product data. In some instances, the operator of a third-party system 230 (e.g., an ERP system) may make data directly available to the operator of the product recommendation system, such that the data can simply be accessed over a network and directly uploaded and further processed. Similarly, with some embodiments, an ERP system, an inventory management system, or a point-of-sale system may be integrated so as to make product data available to the product recommendation system. In some instances, product data may be obtained manually or at least partially through manual efforts, when an administrator of the system 200 views images and directly enters data into the product recommendation system 200, where such data is related to product listings that are associated with third-party sites.

As shown in FIG. 2, the product analysis module 206 also includes an image analysis engine 242 for analyzing images of products as obtained by the data ingestion engine 224. For example, images that are ingested via the data ingestion engine 224 may be analyzed by the color engine 244 or the product characteristics engine 246 of the image analysis engine 242. As such the image analysis engine 242 uses pre-trained machine learning models to automatically identify or detect product characteristics of products that are portrayed in various images, as obtained from various product listings by the data ingestion engine 224. By way of example, the color engine 244 may analyze images of products, and then output color information about the products. Similarly other machine learning models may identify different product characteristics associated with products that are portrayed in images.

A meta-data engine 248 may serve to associate or further process various data associated with products. For example, the meta-data engine 248 may receive product data directly from a product listing (e.g., as ingested by the data ingestion engine), and then associate the meta-data with other product characteristics that have been derived by the image analysis engine.

With some embodiments, product profiles are assigned or associated with product listings. For instance, a product profile may comprise a combination of product characteristics. When a product listing is analyzed and the relevant product has been determined to have a specific combination of product characteristics that map to a predefined product profile, then that product (or, product listing) is associated with the product profile. As with style profiles, a product profile assigned to a product may also have a confidence score to reflect the confidence associated with the outcome of the model predictions, and ultimately the confidence that the product has been mapped to the appropriate product profile. With some embodiments, a product may be mapped to multiple product profiles, with each product profile having a confidence score. These confidence scores can then be used by the product recommendation engine 250 when determining a final ranking of product listings to be recommended to a user based on the user's style profile.

With some embodiments, the product characteristics that collectively represent a product profile may be a combination of product data obtained directly from a product listing (e.g., text-based data describing a product—such as, the size, a description of the product, etc.) and product characteristics derived through the analysis of one or more images of the product. Furthermore, with some embodiments, a user interface may present images of products to a product analyst, who may confirm results (e.g., outputs) of the machine learned models, or alternatively, provide additional input relating to specific product characteristics, after reviewing one or more images of a product. Accordingly, a product profile may also take into consideration and be based on product characteristics that are manually generated through expert review, and so forth.

In various implementations, the entry or access point of an end-user may vary. For example, with some embodiments, the product recommendation system 200 is associated with one or more applications—e.g., a mobile application, and/or a web-based application. Through use of these applications, a user may interact directly with the product recommendations system 200 by providing information about the user, including a selfie image, from which a color profile and style profile are derived. Similarly, through interaction with such an application, the product recommendation system may directly provide the user with product recommendations relating to products that are available through third-party partner websites. Alternatively, consistent with some embodiments, the entry or access point to the product recommendation system may be a third-party website. By way of example, as shown in FIG. 2, the third-party retailer website, with reference 230, includes what is referred to herein as StyleID integration 236. Accordingly, when a user is accessing the third-party website 230 directly, if the user is already a registered end-user of the product recommendations system, the user may be prompted to provide authorization to have the third-party website access account information of the user, including his or her style profile information. As such, after a user has authorized the third-party website to access his or her account information, the third-party website may leverage the user's style profile in generating one or more product recommendations for the user. For instance, with some embodiments, after the product recommendation system has generated a product profile for a product, the product profile is communicated and stored by the third-party retailer, for subsequent user in generating product recommendations. Alternatively, the third-party website may make a request to the product recommendation system, where the request identified the end-user and his or her style profile. In turn, the product recommendation system 200 will provide to the website information about products that match or correspond with the style profile of the user.

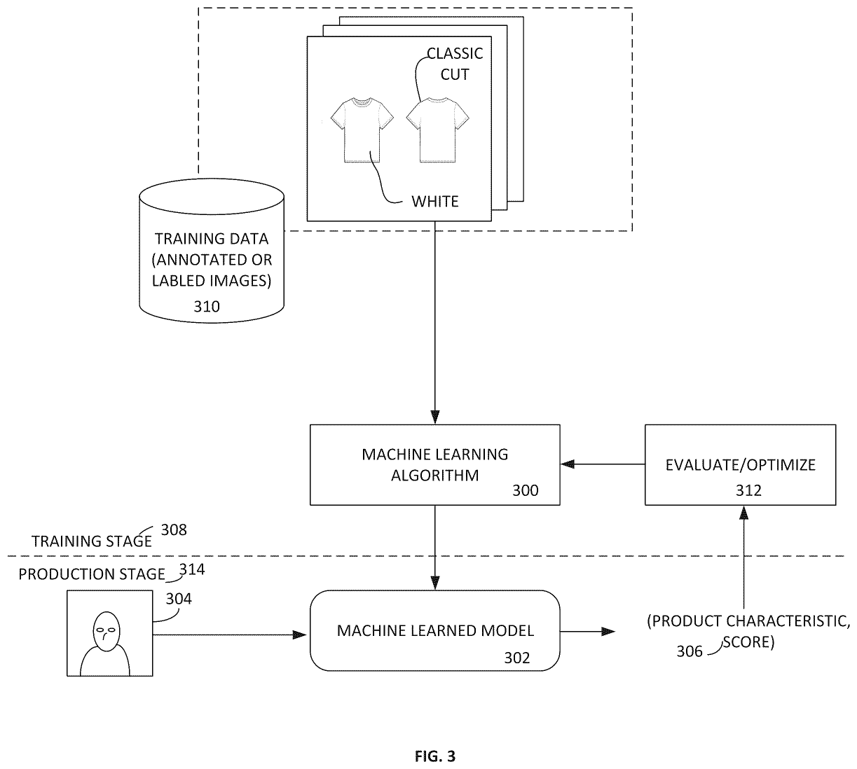

FIG. 3 illustrates an example of how a machine learning algorithm 300 may be used to train one or more machine learned models 302 to analyze an image of a product 304 associated with a product listing, for the purpose of identifying product characteristics 306 of a product, according to some embodiments of the invention. Consistent with some embodiments, a supervised machine learning algorithm 300 may be used to train a machine learned model 302 to generate as output, the identity of a product characteristic detected within the input image 304. For example, in some instances, the output 306 of a model 302 may be a score associated with a particular product characteristic, where the score represents a probability score or a confidence score, indicating the likelihood that the product characteristic has been detected within the image 304. Moreover, in some instances, the machine learned model 302 may output multiples scores, one for each possible product characteristic that the model has been trained to detect or recognize.

As illustrated in FIG. 3, during a training stage 308, a machine learning algorithm 300 or training system is provided with example, annotated or labeled images (e.g., training data 310), with the objective of learning a function (e.g., as represented by the model 302) that will map the example input (e.g., the image) to the output (e.g., the product characteristic and score). The example inputs and outputs that are used to train the model 302 are generally referred to as the training data 310. In this instance, the training data 310 are annotated images, where the image is the input, and the annotation is the expected or desired output. In some instances, the training data 310 may be obtained from an existing data source, for which experts have already annotated the data. However, in other instances, experts may be required to annotate or label the images to generate the training data.

During the training stage 308, after each instance of training data is processed by the machine learned model 302 to generate the output(s) 306 for the input image, an evaluation or optimization operation 312 is performed to determine how to manipulate the function (e.g., the weights) of the machine learned model 302 to generate more accurate predictions. For example, the evaluation operation generally involves comparing the predicted output of the machine learned model with the actual output associated with the example input. A loss function is used to evaluate the performance of the model in generating the desired outputs, based on the provided inputs.

During the training stage 308, as the training data are provided to the learning system 300, the weights of the individual neurons of the neural network model 302 are manipulated to minimize the error or difference, as measured by the loss function. Once fully trained and deployed in a production setting 314, the model 302 is provided with a new selfie image 304, and analyzed to detect product characteristics present in the image 304. The machine learned model 302 then generates the scores 306 that represent the likelihood of specific product characteristics being present in the image.

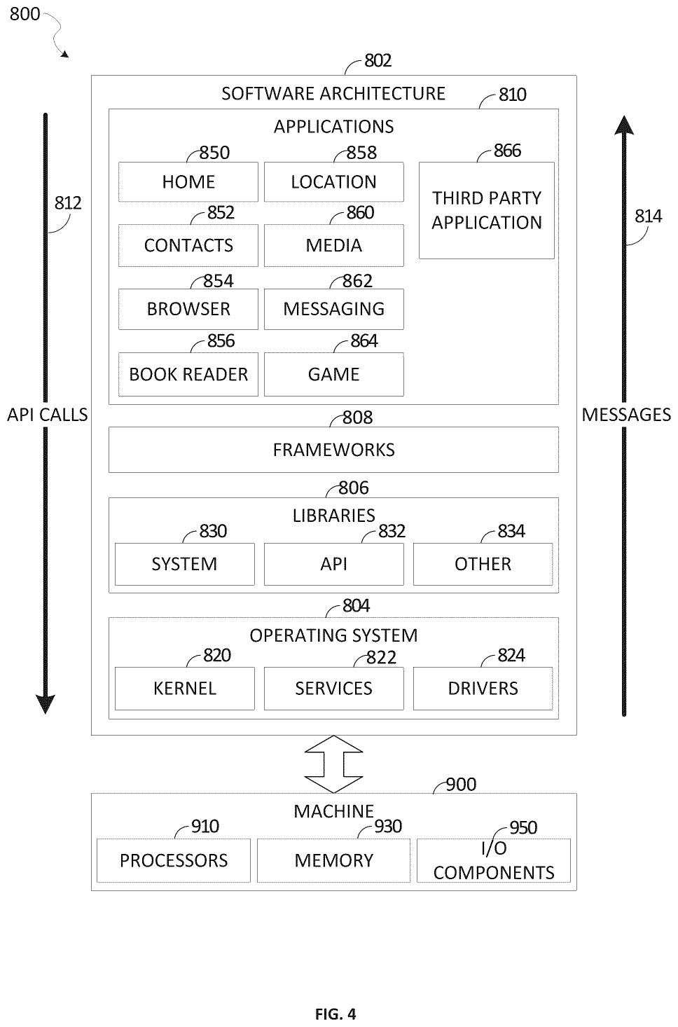

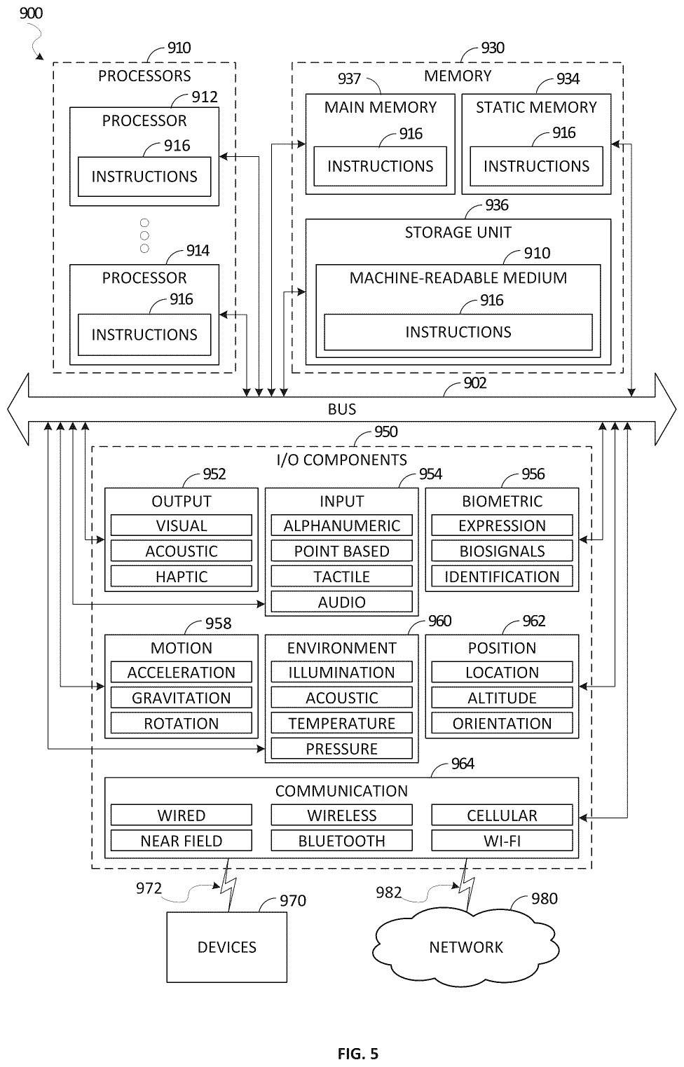

FIG. 4 is a block diagram 800 illustrating a software architecture 802, which can be installed on any of a variety of computing devices to perform methods consistent with those described herein. FIG. 4 is merely a non-limiting example of a software architecture, and it will be appreciated that many other architectures can be implemented to facilitate the functionality described herein. In various embodiments, the software architecture 802 is implemented by hardware such as a machine 900 of FIG. 5 that includes processors 910, memory 930, and input/output (I/O) components 950. In this example architecture, the software architecture 802 can be conceptualized as a stack of layers where each layer may provide a particular functionality. For example, the software architecture 802 includes layers such as an operating system 804, libraries 806, frameworks 808, and applications 810. Operationally, the applications 810 invoke API calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionality. The services 822 can provide other common services for the other software layers. The drivers 824 are responsible for controlling or interfacing with the underlying hardware, according to some embodiments. For instance, the drivers 824 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 806 provide a low-level common infrastructure utilized by the applications 810. The libraries 806 can include system libraries 830 (e.g., C standard library) that can provide functions such as memory allocation functions, string manipulation functions, mathematic functions, and the like. In addition, the libraries 806 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some embodiments. For example, the frameworks 608 provide various GUI functions, high-level resource management, high-level location services, and so forth. The frameworks 808 can provide a broad spectrum of other APIs that can be utilized by the applications 810, some of which may be specific to a particular operating system 804 or platform.

In an example embodiment, the applications 810 include a home application 850, a contacts application 852, a browser application 854, a book reader application 856, a location application 858, a media application 860, a messaging application 862, a game application 864, and a broad assortment of other applications, such as a third-party application 866. According to some embodiments, the applications 810 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 866 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 866 can invoke the API calls 812 provided by the operating system 804 to facilitate functionality described herein.

FIG. 5 illustrates a diagrammatic representation of a machine 900 in the form of a computer system within which a set of instructions may be executed for causing the machine to perform any one or more of the methodologies discussed herein, according to an example embodiment. Specifically, FIG. 5 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example the instructions 916 may cause the machine 900 to execute any one of the methods or algorithms described herein. Additionally, or alternatively, the instructions 916 may implement a system or model as described in connection with FIGS. 2 and 3, and so forth. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory 930 may include a main memory 932, a static memory 934, and a storage unit 936, all accessible to the processors 910 such as via the bus 902. The main memory 930, the static memory 934, and storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

The various memories (i.e., 930, 932, 934, and/or memory of the processor(s) 910) and/or storage unit 936 may store one or more sets of instructions and data structures (e.g., software) embodying or utilized by any one or more of the methodologies or functions described herein. These instructions (e.g., the instructions 916), when executed by processor(s) 910, cause various operations to implement the disclosed embodiments.

As used herein, the terms “machine-storage medium,”“device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,”“computer-storage media,” and “device-storage media” specifically exclude carrier waves, modulated data signals, and other such media, at least some of which are covered under the term “signal medium” discussed below.

In various example embodiments, one or more portions of the network 980 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., HTTP). Similarly, the instructions 916 may be transmitted or received using a transmission medium via the coupling 972 (e.g., a peer-to-peer coupling) to the devices 070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

We claim:

1. A system comprising:
a processor; and
a memory storage device storing instructions thereon, which, when executed by the processor, cause the system to perform operations comprising:
combining output of a color engine with output of a style profile engine to generate for an end-user a style profile;
using the style profile of the end-user as input to a product recommendation engine to generate a plurality of product recommendations for the end-user;
wherein the output of the color engine is a color palette, and the output of the style profile engine is one of a pre-determined number of style profiles determined by a machine learning algorithm analyzing an image of a face of the end-user.

2. The system of claim 1, further comprising:
prompting the end-user to provide biographical information;
storing the provided biographical information in association with the style profile of the end-user as a style identifier; and
using the style identifier as a mechanism for authenticating the end-user of the product recommendation system when accessed via third-party application.

3. The system of claim 2 wherein the operations further comprise:
ingesting product data from a third-party system; and
using one or more pre-trained machine learned models, generating as output a product profile for each product, wherein the product profile of a product is used in generating the product recommendations.

4. The system of claim 3, wherein the product recommendations are generated by matching a style profile of the end-user with a product profile of a product.

5. The system of claim 4, wherein the ingested product data includes at least one of color, shape, fabric, and fashion classification of the product, and wherein the product data is obtained via at least one of web-crawling technology, public or proprietary application programming interface (API) calls, or direct upload from a retailer.

6. The system of claim 5, wherein the matching of the style profile of the end-user with the product profile of a product includes the use of a matching module that evaluates product data and a personal style profile of the end-user based on complex rule-based logic or a data-driven machine learned model.

7. The system of claim 6, wherein the style identifier further includes data relating to product preferences of the end-user, brand preferences of the end-user, style preferences of the end-user, and includes information that aids in conclusion of a purchase transaction, such as payment preferences and shipping preferences.

8. A computer-implemented method comprising:
combining output of a color engine with output of a style profile engine to generate for an end-user a style profile;
using the style profile of the end-user as input to a product recommendation engine to generate a plurality of product recommendations for the end-user;
wherein the output of the color engine is a color palette, and the output of the style profile engine is one of a pre-determined number of style profiles determined by a machine learning algorithm analyzing an image of a face of the end-user.

9. The computer-implemented method of claim 8, further comprising:
prompting the end-user to provide biographical information;
storing the provided biographical information in association with the style profile of the end-user as a style identifier; and
using the style identifier as a mechanism for authenticating the end-user of the product recommendation system when accessed via third-party application.

10. The computer-implemented method of claim 8, further comprising:
ingesting product data from a third-party system; and
using one or more pre-trained machine learned models, generating as output a product profile for each product, wherein the product profile of a product is used in generating the product recommendations.

11. The computer-implemented method of claim 10, wherein the product recommendations are generated by matching a style profile of the end-user with a product profile of a product.

12. The computer-implemented method of claim 11, wherein the ingested product data includes at least one of color, shape, fabric, and fashion classification of the product, and wherein the product data is obtained via at least one of web-crawling technology, public or proprietary application programming interface (API) calls, or direct upload from a retailer.

13. The computer-implemented method of claim 12, wherein the matching of the style profile of the end-user with the product profile of a product includes the use of a matching module that evaluates product data and a personal style profile of the end-user based on complex rule-based logic or a data-driven machine learned model.

14. The computer-implemented method of claim 13, wherein the style identifier further includes data relating to the product preferences of the end-user, brand preferences of the end-user, style preferences of the end-user, and includes information that aids in conclusion of a purchase transaction, such as payment preferences and shipping preferences.

15. A computer-readable medium storing instructions thereon, which, when executed by a processor, cause a system to perform operations comprising:
combining output of a color engine with output of a style profile engine to generate for an end-user a style profile;
using the style profile of the end-user as input to a product recommendation engine to generate a plurality of product recommendations for the end-user;
wherein the output of the color engine is a color palette, and the output of the style profile engine is one of a pre-determined number of style profiles determined by a machine learning algorithm analyzing an image of a face of the end-user.

16. The computer-readable medium of claim 15, wherein the operations further comprise:
prompting the end-user to provide biographical information;
storing the provided biographical information in association with the style profile of the end-user as a style identifier; and
using the style identifier as a mechanism for authenticating the end-user of the product recommendation system when accessed via third-party application.

17. The computer-readable medium of claim 16, wherein the operations further comprise:
ingesting product data from a third-party system; and
using one or more pre-trained machine learned models, generating as output a product profile for each product, wherein the product profile of a product is used in generating the product recommendations.

18. The computer-readable medium of claim 17, wherein the product recommendations are generated by matching a style profile of the end-user with a product profile of a product.

19. The computer-readable medium of claim 18, wherein the ingested product data includes at least one of color, shape, fabric, and fashion classification of the product, and wherein the product data is obtained via at least one of web-crawling technology, public or proprietary application programming interface (API) calls, or direct upload from a retailer.

20. The computer-readable medium of claim 19, wherein the matching of the style profile of the end-user with the product profile of a product includes the use of a matching module that evaluates product data and a personal style profile of the end-user based on complex rule-based logic or a data-driven machine learned model.
